(19) United States
(12) Patent Application Publication
(10) Pub. No.: US 2022/0164713 A1
(43) Pub. Date: May 26, 2022

(54) Proficiency assessment and instructional feedback using explainable artificial intelligence

(71) Applicant: Avant Assessment, LLC, Eugene, OR (US)

(72) Inventors: Shiri Dori-Hacohen, Granby, MA (US); David C. Bong, Eugene, OR (US); Victor Dias de Oliveira Santos, Urbandale, IA (US); Kyle D. Ennis, Springfield, OR (US); Nathan E. Sankary, Los Gatos, CA (US)

(73) Assignee: Avant Assessment, LLC, Eugene, OR (US)

(21) Appl. No.: 17/530,416

(22) Filed: Nov. 18, 2021

Related U.S. Application Data
(60) Provisional application No. 63/117,386, filed on Nov. 23, 2020.

(51) Int. Cl. G06N 20/20; G06N 5/00

(52) U.S. Cl. CPC G06N 20/20; G06F 40/20; G06N 5/003

(57) ABSTRACT

User responses to prompts or queries are classified or scored using explainable artificial intelligence (XAI) according to levels of a defined proficiency scale for selected subject matter. Recommendations for improving user proficiency are generated using XAI based on the proficiency classifications or scores and underlying rationales leading to those classifications or scores. XAI can be employed for identifying user responses that are consistent with predetermined cheating patterns. Prompts and queries can be presented, user responses classified or scored, and recommendation generated in a single session, i.e., in near real time. Disclosed methods can be advantageously employed for assessing user proficiency, and providing recommendations for improving proficiency, in a wide variety of subject areas, including spoken, written, or signed human languages.

### BENEFIT CLAIM

This application claims benefit of U.S. provisional App. No. 63/117,386 entitled “Proficiency assessment and instructional feedback using explainable artificial intelligence” filed Nov. 23, 2020 in the names of Dori-Hacohen et al; said provisional application is incorporated herein by reference in its entirety.

### FIELD OF THE INVENTION

The field of the present invention generally relates to assessment of user proficiency in selected subject matter. In particular, apparatus and methods are disclosed that employ explainable artificial intelligence (XAI) for assessing user proficiency and providing instructional feedback to the user.

### SUMMARY

A method is implemented using a programmed computerized machine and comprises receiving or retrieving responses by a user to one or more prompts or queries, classifying or scoring those responses, and generating recommendations for the user. In many instances the responses are received via a computer network, user interface, or application program interface, often in real time in response to the prompts or queries similarly transmitted to the user. In other instances cached or stored responses can be retrieved from digital storage media. The prompts or queries pertain to selected subject matter and are for assessing proficiency of the user in the selected subject matter (e.g., human languages, mathematics, physical or biological sciences, social sciences, humanities, computer science or computer engineering, law, medicine or medical sciences, engineering or engineering sciences, music or visual arts, or other academic or vocational subject matter areas). Explainable artificial intelligence (XAI) is used to automatically classify or score user responses. Responses are classified or scored according to levels of a defined proficiency scale for the selected subject matter. Based on the proficiency classifications or scores and the underlying rationales leading to those classifications or scores, XAI is used to automatically generate recommendations for actions to be taken by the user (i.e., as part of an actionable report). Those recommended actions, if taken by the user, increase the likelihood of the user achieving a higher proficiency classification or score for a response to a subsequent prompt or query. In other words, the recommended actions are intended to improve user proficiency.

Recommendations can be generated (using XAI) in specific response to corresponding deficiencies observed in or inferred from user responses (also using XAI). A report can include the recommendations as well as a listing, tabulation, or summary of proficiency scale classifications or scores of the user responses, or an overall classification or score of the user's proficiency. In some examples AI (XAI or otherwise) can be employed for automatically generating one or more of the prompts or queries. In some instances the recommendations or report can be generated and transmitted within a single, continuous user session (e.g., in near real time) during which prompts or queries are presented and the user generates and transmits corresponding responses. In other instances the prompts or queries can be presented, responses received and classified or scored, and one or more recommendations generated over multiple sessions or in a delayed manner. In some examples, AI (XAI or otherwise) can be employed for identifying user responses that are consistent with predetermined cheating patterns (in some instances even if XAI is not used for classification or scoring of responses or generation of recommendations). Disclosed methods can be advantageously employed for assessing user proficiency, and providing recommendations for improving proficiency, in a wide variety of subject areas, including but not limited to proficiency in a spoken, written, or signed human language.

Objects and advantages pertaining to proficiency assessment and feedback may become apparent upon referring to the examples illustrated in the drawings and disclosed in the following written description or appended claims.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a flow diagram illustrating an example of an inventive method disclosed herein. “XAI” indicates a process employing one or more XAI protocols.

FIG. 2 is a flow diagram illustrating an example of an inventive method disclosed herein. “XAI” indicates a process employing one or more XAI protocols; “(XAI)” indicates a process optionally employing one or more XAI protocols.

FIG. 3 illustrates a specific implementation of a disclosed inventive method for assessing language proficiency.

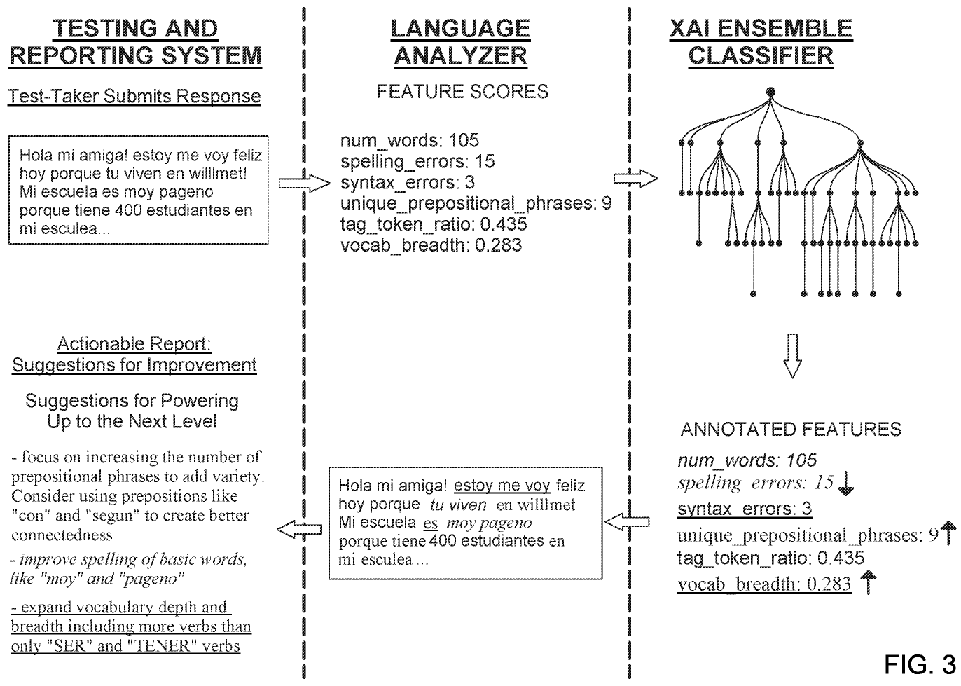

The examples depicted are shown only schematically; all features may not be shown in full detail; for clarity certain features or structures may be exaggerated or diminished relative to others or omitted entirely. The examples shown are only examples and should not be construed as limiting the scope of the present disclosure or appended claims.

### DETAILED DESCRIPTION

A variety of proficiency assessment methodologies exist in a variety of subject areas including, e.g., languages, mathematics, one or more physical or biological sciences, or other academic or vocational subject matter areas. Some are administered in person; others can be administered remotely, e.g., via a computer network such as the Internet. Recently demand for large scale and widespread remote assessment has increased dramatically, exceeding the available capacity of human raters or evaluators.

In some previous examples of proficiency assessment, Automated Essay Scoring (AES) systems have been employed for English language essays, and have been under ongoing development for several decades. Some recent examples employ, e.g., Latent Semantic Analysis or artificial intelligence (AI) such as neural networks. AI systems employed thus far have been of the so-called black-box variety, wherein the specific rationale or reasoning behind a given classification, score, or rating cannot be readily discerned by or presented to a user.

In the present disclosure, it is now recognized that a rating or evaluation based on explainable artificial intelligence (XAI) is desirable for at least two important reasons. First, many proficiency assessments, including language proficiency assessments, can be high-stakes affairs for the users being assessed, being used for, e.g., determining class placement or credit, academic admission, grading, promotion, or graduation, or qualification for employment. Leaving the fate of those being assessed under the control of a black-box mechanism is undesirable but hard to avoid given the current state of the art. Use of XAI can alleviate concerns of unfairness, bias, or inaccuracy, while increasing the transparency of the AI being utilized.

Second, availability of the reasons or rationales upon which a score or rating is based, as would be the case if XAI were employed, affords the opportunity for the user to improve his or her proficiency in specific response to those reasons or rationales. A sufficiently sophisticated XAI protocol can offer insights into what a user would need to do in order to improve his or her proficiency to reach the next level of proficiency (and not merely “teach to the test”). Using an XAI protocol for assessment enables the generation of specific, actionable recommendations tailored to the user that, if followed, would likely result in improved proficiency and therefore an improved score or rating of that user's proficiency in a subsequent assessment. That specifically targeted instructional capability is beyond what typically can be provided by existing proficiency tests evaluated by human raters or evaluators. Any human-generated recommendations would lack consistency from one rater to the next, or even from one assessment to the next with the same user or the same rater. Such human-generated assessment and recommendations could not be scaled to the degree necessary to meet current or future demand for remote or in-class assessment, test preparation, and instruction, and cannot be readily implemented for real-time instructional feedback to a user. The computer-implemented methods disclosed herein, developed based on the recognition of the specific utility of explainable AI can be applied to both assessment and instruction (i.e., improvement of user proficiency) in various different subject matter areas, e.g., languages, mathematics, physical or biological sciences, or other academic or vocational subject matter areas.

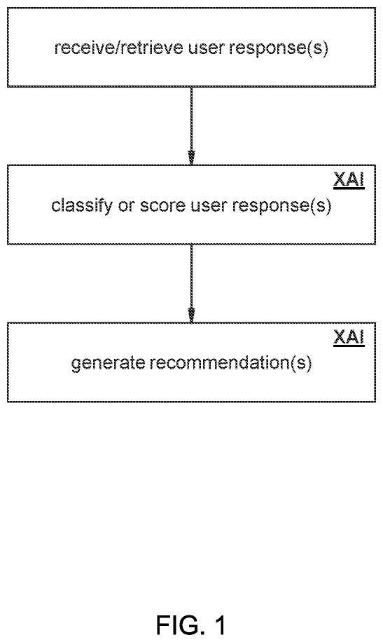

Accordingly, a method in accordance with the present disclosure (e.g., as in FIG. 1) is implemented using a programmed computerized machine and includes using one or more XAI protocols (i) to classify or score user responses to prompts or queries according to a defined proficiency scale, and (ii) to generate specific recommendations for improving user proficiency based on rationales relied upon by the XAI protocol to classify or score the user responses.

In the course of an assessment, a user responds to one or more prompts or queries pertaining to a selected subject area. The user can be, e.g., a student or other learner of the selected subject area, or any person whose proficiency in the subject area requires assessment, testing, or evaluation. In some examples those responses can be received from the user via a computer network, a local or remote user interface (UI), or an application program interface (API); in some examples cached or stored responses can be retrieved from one or more local or remote digital storage media. The prompts or queries pertain to selected subject matter and are for assessing proficiency of the user in the selected subject matter. Any subject matter can be assessed, provided that the XAI protocol is suitably adapted or trained. In some examples the selected subject matter can be a specified written, spoken, or signed human language. English, Spanish, French, and Mandarin are common examples; any written, spoken, or signed human language can be specified, provided that sufficiently many prompts or queries have been made available and that the one or more XAI protocols employed have been trained or otherwise adapted for that language. Other, non-language subject matter areas can be specified, as noted above, again provided that sufficiently many prompts or queries are made available and that the XAI protocol is suitably adapted or trained.

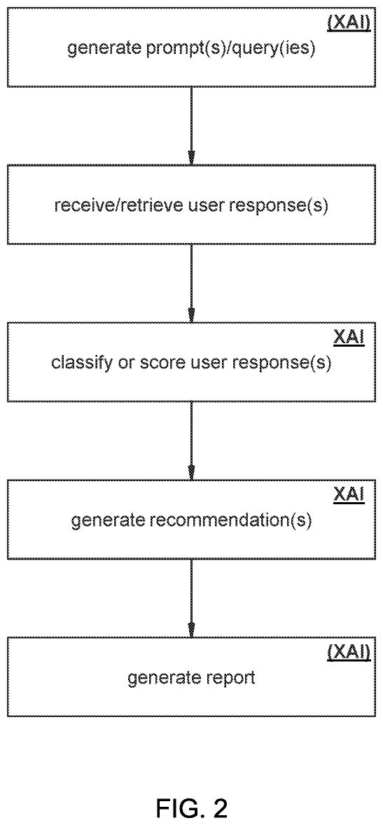

In some examples the prompts or queries can be transmitted to the user via a computer network, the UI, or the API, often the same that is also used to receive the user responses. In some examples prompts or queries can be drawn from an existing collection or repository of such items written, composed, or formulated by humans for assessment purposes. In some examples, those prompts or queries can be automatically generated or selected using one or more AI protocols (XAI or otherwise; e.g., as in FIG. 2). In some such examples wherein prompts or queries are generated using an AI protocol, some prompts or queries can be based on or derived from one or more user responses to earlier prompts or queries for corrective, remedial, or instructive purposes, e.g., to guide the user away from a previous mistake or to address a specific deficiency in a previous response. In some such examples wherein prompts or queries are generated using an AI protocol, prompts or queries can be based on or derived from publicly available materials, e.g., online or in textbooks. In some instances prompts or queries can be generated based on any suitable combination of the above.

Using one or more XAI protocols, each user response, or in some instances groups of responses, are automatically classified or scored according to levels of a defined proficiency scale for the selected subject matter. For example, some language assessment systems employ a numeric scale (e.g., a 1-to-9 scale, with 9 being most proficient). Other suitable quantitative, qualitative, or descriptive classification or scoring systems can be employed. Because explainable AI (XAI) is employed, the rationale or reasoning that led to the proficiency classification or score of each response is known or can be derived from the XAI model, and is available to be employed in subsequent steps.

Using one or more XAI protocols, based on one or more of the classifications or scores and the rationales relied upon that resulted in those classifications or scores, one or more recommendations for the user are automatically generated. The generated recommendations are personalized, specific, explicit actionable items that can be acted upon by that specific user to improve his or her proficiency. The computer-implemented methods therefore can provide instruction as well as assessment. The recommendations can be generated (using an XAI protocol) in specific response to one or more corresponding deficiencies observed in or inferred from the user responses (also using an XAI protocol), or observed or inferred opportunities for specific improvement. The user acting on the generated recommendations can increase the likelihood of achieving a higher proficiency classification or score for the user's response to a subsequent prompt or query pertaining to the selected subject matter. Following the recommendations can enable the user to improve his or her proficiency in the selected subject matter; care should be taken that the recommendations do not merely “teach to the test”.

Using one or more XAI protocols, based on one or more of the classifications or scores or the rationales relied upon that resulted in those classifications or scores, in some examples one or more positive feedback items for the user can be generated automatically. Instead of or in addition to corrective or remedial recommendations (e.g., that could be regarded as negative feedback), the generated recommendations can include personalized, specific items that highlight items that the user has performed particularly well compared to their proficiency level or that of other users, or strengths that they can build upon. The user retaining or improving their accomplishments in the generated positive feedback areas can increase the likelihood of maintaining proficiency or achieving a higher proficiency classification or score for the user's response to a subsequent prompt or query pertaining to the selected subject matter. The feedback can also improve the user's confidence in their existing abilities in the selected subject matter.

Using one or more XAI protocols, the generated recommendations (e.g., corrective, instructive, remedial, or positive feedback recommendations) can include machine-readable data which can be converted to human-readable format. This data can be adapted by the XAI protocol and combined with other instructional content. In some examples, the data can be combined with predefined templates created by humans. In some examples, the data can be combined with content or explanations generated by the XAI automatically.

In some examples the generated recommendations can be included in a report (e.g., as in FIG. 2) that also includes a listing, tabulation, or summary of the one or more proficiency scale levels into which the one or more user responses are classified or scored, or an overall classification or score of the user's proficiency in the selected subject matter based on the classifications or scores of multiple responses. In some examples the recommendations or report can be transmitted to the user via the computer network, the UI, or the API; in other examples the recommendations or report can be stored on a digital storage medium. In some examples the report can also be transmitted to or otherwise made available to an instructor, educator, or supervisor of the user.

Generation of such personalized, actionable recommendations for improving user proficiency is a new and useful result provided by methods disclosed and claimed herein. In addition to consistency and scalability, use of one or more XAI protocols also enables transmission and presentation of the prompts or queries, reception and classification or scoring of user responses, and generation and transmission of recommendations all within a single, continuous user session, i.e., in near real time. The disclosed methods therefore can be deployed not only as an assessment tool but also as an educational tool, providing near real time, interactive assessment and instruction for the user, and potentially resulting in improvements of user proficiency.

Many different XAI protocols exist, and any one or more suitable XAI protocols can be employed in inventive methods disclosed herein. What follows are numerous examples that can be employed; the examples are not intended to be exhaustive.

In some examples, the one or more XAI protocols can include one or more supervised learning approaches configured for classifying or scoring a user response. Such supervised approaches would be trained on datasets of example responses with assigned scores (i.e., labelled data). In some examples, the one or more XAI protocols can include one or more supervised learning approaches configured for generating a personalized, actionable recommendation based on a user response. Such supervised approaches would be trained on labelled datasets of example responses with recommendations.

In some examples, the one or more XAI protocols can include one or more unsupervised learning approaches configured for classifying or scoring a user response. In some examples, the one or more XAI protocols can include one or more unsupervised learning approaches configured for generating a recommendation based on a user response. Such unsupervised approaches would not require labelled training data. In some examples, so-called semi-supervised or distantly supervised learning approaches can be employed for classification, scoring, or generating recommendations.

In some examples, the one or more XAI protocols can include one or more decision trees configured for classifying or scoring a user response. In some examples, the one or more XAI protocols can include one or more decision trees configured for generating a recommendation based on a user response.

In some examples, the one or more XAI protocols can include one or more expert systems configured for classifying or scoring a user response. In some examples, the one or more XAI protocols can include one or more expert systems configured for generating a recommendation based on a user response. Expert systems can include such specific methods as rule-based expert systems, expert systems that include a knowledge-base and inference engine, or others.

In some examples, the one or more XAI protocols can include one or more artificial neural networks configured for classifying or scoring a user response. In some examples, the one or more XAI protocols can include one or more artificial neural networks systems configured for generating a recommendation based on a user response. Artificial neural networks may include various subcomponents or types, including but not limited to Multi-Layer Perceptron, Recurrent Neural Networks, Generative Adversarial Networks, Convolutional Neural Networks, Long short-term memory (LSTM), or others.

In some examples, the one or more XAI protocols can include one or more reinforcement learning approaches configured for classifying or scoring a user response. In some examples, the one or more XAI protocols can include one or more reinforcement learning approaches configured for generating a recommendation based on a user response.

In some examples, the one or more XAI protocols can include one or more ensemble classifiers configured for classifying or scoring a user response. In some examples, the one or more XAI protocols can include one or more ensemble classifiers configured for generating a recommendation based on a user response. Ensemble classifiers can be constructed by choosing a set of two or more classifiers whose individual decisions are combined in some way. Various ensemble approaches can be used, including but not limited to stacking, boosting, bagging, or model selection.

A wide variety of modalities can be used in the prompts or queries or for user response. A given prompt or query presented in one modality or combination of modalities can elicit a response in the same modality or combination of modalities or in a different modality or combination of modalities. Suitable modalities can include oral, aural, verbal, spoken, signed, textual, written, musical, visual, graphic, video, symbolic, formulaic, tactile, olfactory, gustatory, emotive, and so forth. The choice of one or more modalities can in some instances depend on the subject area, e.g., oral, aural, textual, signed, visual, or written modalities might be well suited for assessment of language proficiency, while symbolic and formulaic modalities might be well suited for assessment of mathematical proficiency.

In some examples wherein one or more user responses are written, spoken, or signed in a human language, user responses can be classified or scored using one or more XAI protocols in conjunction with one or more natural language processing (NLP) techniques. In some examples, user responses can be classified or scored using one or more XAI protocols in conjunction with one or more machine vision techniques. In some examples, user responses can be classified or scored using one or more XAI protocols in conjunction with one or more speech recognition techniques. In some examples, user responses can be classified or scored using one or more XAI protocols in conjunction with one or more video recognition techniques. In some examples, user responses can be classified or scored using one or more XAI protocols in conjunction with one or more machine perception techniques.

In some examples, the one or more XAI protocols can include one or more features and feature weights chosen by the classifier in order to determine the proficiency level. In some examples, the one or more XAI protocols can include such features and feature weights as input for generating a recommendation based on a user response.

In some examples, the one or more XAI protocols can include one or more statistical analyses on various proficiency levels. In some examples, the one or more XAI protocols can include such statistical analyses as input for generating a recommendation based on a user response.

For remote testing, e.g., online testing, cheating is a significant concern. Cheating can take several forms, including but not limited to looking up answers or copying answers from unauthorized sources, using a dictionary or machine translation of a foreign language item, acquiring prior knowledge of queries or prompts, having another person assist with the assessment, or having another person do the assessment in place of the user as a so-called “ringer”. Some of those (assistance or “ringer”) can be detected, e.g., by requiring a camera and perhaps also a microphone at the user's computer. In some examples one or more AI protocols (XAI or otherwise) can be used to detect cheating, in some instances in addition to the methods disclosed above, and in some instances independent of those disclosed methods.

In examples wherein the XAI protocol is used to generate prompts or queries, the large number of possible different prompts or queries can reduce the impact of user foreknowledge of prompts or queries. There are simply too many different prompts or queries that can be presented at any given time, so that no user could be aware of more than a fraction of them; the likelihood of receiving a prompt or query for which the user has foreknowledge would be correspondingly reduced.

In some examples, one or more AI protocols (XAI or otherwise) can be employed to identify one or more user responses that are consistent with one or more predetermined cheating patterns. In some examples, direct comparison of the user response to one or more known examples of cheating responses can be employed; detection of a match between the user response and one of the known examples indicates cheating (i.e., plagiarism detection). In some examples, cheating can be indicated by inconsistency between classification or scoring of the identified user response and classifications or scoring of other, non-identified responses of that same user. For example, two responses scored at 8 on a 1-to-9 scale among more numerous responses of that same user rated at 2, 3, or 4 on the 1-to-9 scale can indicate that the user cheated for the two inconsistent responses. In some examples a typing rate for a written response, or a speaking rate for an oral response, that is significantly faster or steadier than for most other responses can indicate cheating. For example, a user copying an essay or reading from a script might write or speak faster and with fewer pauses than he or she would if composing the essay or speaking extemporaneously. In some examples recognition of certain patterns within the identified response can be indicative of a machine-generated response, e.g., a machine translation. In some examples wherein the selected subject matter is a specified written, spoken, or signed human language, one or more NLP techniques can be employed in conjunction with one or more XAI protocols. In some examples, identification of one or more user responses that are consistent with one or more predetermined cheating patterns is not sufficient to conclude that the user cheated. In such examples the identified responses are flagged for human review, and only determined to indicate cheating if the human reviewer concurs. Such a human-in-the-loop arrangement can allay user fears that the computer-implemented method would incorrectly identify one of their responses as representing cheating. Use of explainable AI also reflects favorably on the cheating detection methods, because the rationale for flagging a response as possibly cheating can be reviewed and understood by the human user.

Any one of the preceding methods can be performed using a programmed computerized machine comprising one or more electronic processors and one or more tangible computer-readable storage media operationally coupled to the one or more processors. The machine can be structured and programmed to perform any of the methods described above.

An article comprising a tangible medium that is not a propagating signal can be encoded with computer-readable instructions that, when applied to a computerized machine, program the computerized machine to perform any of the methods described above.

The systems and methods disclosed herein, implemented using a “programmed computerized machine,” can be implemented as or with general or special purpose computers or servers or other programmable hardware devices programmed through software, or as hardware or equipment “programmed” through hard wiring, or a combination of the two. A “computer” or “server” can comprise a single machine or can comprise multiple interacting machines (located at a single location or at multiple remote locations, e.g., in the “cloud”). Computer programs or other software code, if used, can be implemented in tangible, non-transient, temporary or permanent storage or replaceable media, such as by including programming in microcode, machine code, network-based or web-based or distributed software modules that operate together, RAM, ROM, CD-ROM, CD-ft CD-R/W, DVD-ROM, DVD±R, DVD±R/W, hard drives, thumb drives, flash memory, optical media, magnetic media, semiconductor media, or any future computer-readable storage alternatives. Electronic indicia of prompts, queries, user responses, proficiency levels, recommendation, classifiers, models, programming instructions, and so forth can be read from, received from, or stored on any of the tangible, non-transitory computer-readable media mentioned herein.

In addition to the preceding, the following example embodiments fall within the scope of the present disclosure or appended claims:

Example 1. A method implemented using a programmed computerized machine, the method comprising: (a) receiving, via a computer network, a local or remote user interface (UI), or an application program interface (API), or retrieving, from one or more local or remote digital storage media, one or more responses by a user to one or more corresponding prompts or queries pertaining to selected subject matter for assessing proficiency of the user in the selected subject matter; (b) using one or more explainable artificial intelligence (XAI) protocols, automatically classifying or scoring the one or more user responses according to levels of a defined proficiency scale for the selected subject matter; and (c) using one or more XAI protocols, based on one or more of the classifications or scores and rationales therefor, automatically generating one or more recommendations for actions to be taken by the user for increasing the user's proficiency and thereby increasing the likelihood of the user achieving a higher proficiency classification or score for the user's response to a subsequent prompt or query pertaining to the selected subject matter.

Example 2. The method of Example 1 further comprising automatically generating a report that includes the one or more recommendations and (i) a listing, tabulation, or summary of the one or more levels of the proficiency scale into which the user responses are classified or scored, or (ii) an overall classification or score of the user's proficiency in the selected subject matter based on the classifications or scores of the one or more responses.

Example 3. The method of any one of Examples 1 or 2 further comprising transmitting, via the computer network, the local or remote UI, or the API, the one or more prompts or queries pertaining to the selected subject matter for presentation to the user.

Example 4. The method of any one of Examples 1 through 3 further comprising, using one or more XAI protocols, automatically generating or selecting one or more of the prompts or queries for presentation to the user.

Example 5. The method of any one of Examples 1 through 4 further comprising transmitting, via the computer network, the local or remote UI, or the API, the one or more generated recommendations for presentation to the user.

Example 6. The method of Example 5 wherein one or more of the recommendations are generated and transmitted within a single, continuous user session during which the corresponding prompts or queries are presented, and the user generates and transmits the corresponding responses.

Example 7. The method of any one of Examples 1 through 6 wherein one or more of the recommendations are generated automatically, using the one or more XAI protocols, in specific response to one or more corresponding deficiencies observed in or inferred from one or more user responses using the one or more XAI protocols.

Example 8. The method of any one of Examples 1 through 7 wherein the one or more XAI protocols include one or more supervised, unsupervised, semi-supervised, distantly supervised, or reinforced learning protocols configured for classifying or scoring a user response or for generating a recommendation.

Example 9. The method of any one of Examples 1 through 8 wherein the one or more XAI protocols include one or more decision trees configured for classifying or scoring a user response or for generating a recommendation.

Example 10. The method of any one of Examples 1 through 9 wherein the one or more XAI protocols include one or more sequential or parallel ensemble classifiers configured for classifying or scoring a user response or for generating a recommendation.

Example 11. The method of any one of Examples 1 through 10 wherein the one or more XAI protocols include one or more expert systems configured for classifying or scoring a user response or for generating a recommendation.

Example 12. The method of any one of Examples 1 through 11 wherein the one or more XAI protocols include one or more artificial neural networks configured for classifying or scoring a user response or for generating a recommendation.

Example 13. The method of any one of Examples 1 through 12 wherein the selected subject matter is a specific written, spoken, or signed human language.

Example 14. The method of any one of Examples 1 through 13 wherein user responses are classified or scored using one or more XAI protocols in conjunction with one or more natural language processing (NLP) techniques.

Example 15. The method of any one of Examples 1 through 14 wherein one or more of the prompts or queries are aural prompts or queries.

Example 16. The method of any one of Examples 1 through 15 wherein one or more of the user responses are oral responses.

Example 17. The method of any one of Examples 1 through 16 wherein one or more of the prompts or queries are written prompts or queries.

Example 18. The method of any one of Examples 1 through 17 wherein one or more of the user responses are written responses.

Example 19. The method of any one of Examples 1 through 18 wherein at least one user response is an essay written by the user in response to one of the prompts or queries.

Example 20. The method of any one of Examples 1 through 19 wherein one or more of the prompts or queries are signed prompts or queries.

Example 21. The method of any one of Examples 1 through 20 wherein one or more of the user responses are signed responses.

Example 22. The method of any one of Examples 1 through 21 further comprising, using one or more XAI protocols, automatically identifying one or more user responses that are consistent with one or more predetermined cheating patterns.

Example 23. A method implemented using a programmed computerized machine, the method comprising: (a) receiving, via a computer network, a local or remote user interface (UI), or an application program interface (API), or retrieving, from one or more local or remote digital storage media, one or more responses by a user to one or more corresponding prompts or queries pertaining to selected subject matter for assessing proficiency of the user in the selected subject matter; and (b) using one or more XAI protocols, automatically identifying one or more user responses that are consistent with one or more predetermined cheating patterns.

Example 24. The method of any one of Examples 22 or 23 wherein automatically identifying one or more user responses that are consistent with one or more predetermined cheating patterns includes directly comparing the user response to one or more known examples of cheating responses and detecting a match, overlap, or correlation between the user response and one of the known examples.

Example 25. The method of any one of Examples 22 through 24 wherein automatically identifying one or more user responses that are consistent with one or more predetermined cheating patterns includes detecting inconsistency between a classification or score of the identified user response and classifications or scores of other, non-identified user responses.

Example 26. The method of any one of Examples 22 through 25 wherein automatically identifying one or more user responses that are consistent with one or more predetermined cheating patterns includes detecting a typing rate for a written response, or a speaking rate for an oral response, for the identified response that is substantially faster than that of other, non-identified user responses.

Example 27. The method of any one of Examples 22 through 26 wherein automatically identifying one or more user responses that are consistent with one or more predetermined cheating patterns includes recognizing patterns within the identified response indicative of a machine-generated response.

Example 28. The method of any one of Examples 22 through 27 wherein automatically identifying one or more user responses that are consistent with one or more predetermined cheating patterns includes use of one or more NLP techniques in conjunction with one or more XAI protocols.

Example 29. The method of any one of Examples 22 through 28 further comprising evaluating, using a human evaluator, the identified user responses, and only designating as cheating responses those identified user responses evaluated as such by the human evaluator.

Example 30. The method of any one of Examples 22 through 29 wherein the selected subject matter is a specific written, spoken, or signed human language.

Example 31. A programmed computerized machine comprising one or more electronic processors and one or more tangible computer-readable storage media operationally coupled to the one or more processors, the machine being structured and programmed to perform the method of any one of Examples 1 through 30.

Example 32. An article comprising a tangible medium that is not a propagating signal encoding computer-readable instructions that, when applied to a computerized machine, program the computerized machine to perform the method of any one of Examples 1 through 30.

It is intended that equivalents of the disclosed example embodiments and methods shall fall within the scope of the present disclosure or appended claims. It is intended that the disclosed example embodiments and methods, and equivalents thereof, may be modified while remaining within the scope of the present disclosure or appended claims.

In the foregoing Detailed Description, various features may be grouped together in several example embodiments for the purpose of streamlining the disclosure. This method of disclosure is not to be interpreted as reflecting an intention that any claimed embodiment requires more features than are expressly recited in the corresponding claim. Rather, as the appended claims reflect, inventive subject matter may lie in less than all features of a single disclosed example embodiment. Therefore, the present disclosure shall be construed as implicitly disclosing any embodiment having any suitable subset of one or more features—which features are shown, described, or claimed in the present application—including those subsets that may not be explicitly disclosed herein. A “suitable” subset of features includes only features that are neither incompatible nor mutually exclusive with respect to any other feature of that subset. Accordingly, the appended claims are hereby incorporated in their entirety into the Detailed Description, with each claim standing on its own as a separate disclosed embodiment. In addition, each of the appended dependent claims shall be interpreted, only for purposes of disclosure by said incorporation of the claims into the Detailed Description, as if written in multiple dependent form and dependent upon all preceding claims with which it is not inconsistent. It should be further noted that the cumulative scope of the appended claims can, but does not necessarily, encompass the whole of the subject matter disclosed in the present application.

The following interpretations shall apply for purposes of the present disclosure and appended claims. The words “comprising,” “including,” “having,” and variants thereof, wherever they appear, shall be construed as open-ended terminology, with the same meaning as if a phrase such as “at least” were appended after each instance thereof, unless explicitly stated otherwise. The article “a” shall be interpreted as “one or more” unless “only one,” “a single,” or other similar limitation is stated explicitly or is implicit in the particular context; similarly, the article “the” shall be interpreted as “one or more of the” unless “only one of the,” “a single one of the,” or other similar limitation is stated explicitly or is implicit in the particular context. The conjunction “or” is to be construed inclusively unless: (i) it is explicitly stated otherwise, e.g., by use of “either . . . or,” “only one of,” or similar language; or (ii) two or more of the listed alternatives are understood or disclosed (implicitly or explicitly) to be incompatible or mutually exclusive within the particular context. In that latter case, “or” would be understood to encompass only those combinations involving non-mutually-exclusive alternatives. In one example, each of “a dog or a cat,” “one or more of a dog or a cat,” and “one or more dogs or cats” would be interpreted as one or more dogs without any cats, or one or more cats without any dogs, or one or more of each. In another example, each of “a dog, a cat, or a mouse,” “one or more of a dog, a cat, or a mouse,” and “one or more dogs, cats, or mice” would be interpreted as (i) one or more dogs without any cats or mice, (ii) one or more cats without and dogs or mice, (iii) one or more mice without any dogs or cats, (iv) one or more dogs and one or more cats without any mice, (v) one or more dogs and one or more mice without any cats, (vi) one or more cats and one or more mice without any dogs, or (vii) one or more dogs, one or more cats, and one or more mice. In another example, each of “two or more of a dog, a cat, or a mouse” or “two or more dogs, cats, or mice” would be interpreted as (i) one or more dogs and one or more cats without any mice, (ii) one or more dogs and one or more mice without any cats, (iii) one or more cats and one or more mice without and dogs, or (iv) one or more dogs, one or more cats, and one or more mice; “three or more,” “four or more,” and so on would be analogously interpreted.

For purposes of the present disclosure or appended claims, when terms are employed such as “about equal to,” “substantially equal to,” “greater than about,” “less than about,” and so forth, in relation to a numerical quantity, standard conventions pertaining to measurement precision and significant digits shall apply, unless a differing interpretation is explicitly set forth. For null quantities described by phrases such as “substantially prevented,” “substantially absent,” “substantially eliminated,” “about equal to zero,” “negligible,” and so forth, each such phrase shall denote the case wherein the quantity in question has been reduced or diminished to such an extent that, for practical purposes in the context of the intended operation or use of the disclosed or claimed apparatus or method, the overall behavior or performance of the apparatus or method does not differ from that which would have occurred had the null quantity in fact been completely removed, exactly equal to zero, or otherwise exactly nulled.

For purposes of the present disclosure and appended claims, any labelling of elements, steps, limitations, or other portions of an embodiment, example, or claim (e.g., first, second, third, etc., (a), (b), (c), etc., or (i), (ii), (iii), etc.) is only for purposes of clarity, and shall not be construed as implying any sort of ordering or precedence of the portions so labelled. If any such ordering or precedence is intended, it will be explicitly recited in the embodiment, example, or claim or, in some instances, it will be implicit or inherent based on the specific content of the embodiment, example, or claim. In the appended claims, if the provisions of 35 USC § 112(f) are desired to be invoked in an apparatus claim, then the word “means” will appear in that apparatus claim. If those provisions are desired to be invoked in a method claim, the words “a step for” will appear in that method claim. Conversely, if the words “means” or “a step for” do not appear in a claim, then the provisions of 35 USC § 112(f) are not intended to be invoked for that claim.

If any one or more disclosures are incorporated herein by reference and such incorporated disclosures conflict in part or whole with, or differ in scope from, the present disclosure, then to the extent of conflict, broader disclosure, or broader definition of terms, the present disclosure controls. If such incorporated disclosures conflict in part or whole with one another, then to the extent of conflict, the later-dated disclosure controls.

The Abstract is provided as required as an aid to those searching for specific subject matter within the patent literature. However, the Abstract is not intended to imply that any elements, features, or limitations recited therein are necessarily encompassed by any particular claim. The scope of subject matter encompassed by each claim shall be determined by the recitation of only that claim.

What is claimed is:

1. A method implemented using a programmed computerized machine, the method comprising:
(a) receiving, via a computer network, a local or remote user interface (UI), or an application program interface (API), or retrieving, from one or more local or remote digital storage media, one or more responses by a user to one or more corresponding prompts or queries pertaining to selected subject matter for assessing proficiency of the user in the selected subject matter;
(b) using one or more explainable artificial intelligence (XAI) protocols, automatically classifying or scoring the one or more user responses according to levels of a defined proficiency scale for the selected subject matter; and
(c) using one or more XAI protocols, based on one or more of the classifications or scores and rationales therefor, automatically generating one or more recommendations for actions to be taken by the user for increasing the user's proficiency and thereby increasing the likelihood of the user achieving a higher proficiency classification or score for the user's response to a subsequent prompt or query pertaining to the selected subject matter.

2. The method of claim 1 further comprising automatically generating a report that includes the one or more recommendations and (i) a listing, tabulation, or summary of the one or more levels of the proficiency scale into which the user responses are classified or scored, or (ii) an overall classification or score of the user's proficiency in the selected subject matter based on the classifications or scores of the one or more responses.

3. The method of claim 1 further comprising transmitting, via the computer network, the local or remote UI, or the API, (i) the one or more prompts or queries pertaining to the selected subject matter for presentation to the user, or (ii) the one or more generated recommendations for presentation to the user.

4. The method of claim 1 further comprising, using one or more XAI protocols, automatically generating or selecting one or more of the prompts or queries for presentation to the user.

5. The method of claim 1 wherein one or more of the recommendations are generated automatically, using the one or more XAI protocols, in specific response to one or more corresponding deficiencies observed in or inferred from one or more user responses using the one or more XAI protocols.

6. The method of claim 1 wherein the one or more XAI protocols include one or more supervised, unsupervised, semi-supervised, distantly supervised, or reinforced learning protocols configured for classifying or scoring a user response or for generating a recommendation.

7. The method of claim 1 wherein the one or more XAI protocols include one or more decision trees configured for classifying or scoring a user response or for generating a recommendation.

8. The method of claim 1 wherein the one or more XAI protocols include one or more sequential or parallel ensemble classifiers configured for classifying or scoring a user response or for generating a recommendation.

9. The method of claim 1 wherein the one or more XAI protocols include one or more expert systems configured for classifying or scoring a user response or for generating a recommendation.

10. The method of claim 1 wherein the one or more XAI protocols include one or more artificial neural networks configured for classifying or scoring a user response or for generating a recommendation.

11. The method of claim 1 wherein the selected subject matter is a specific written, spoken, or signed human language.

12. The method of claim 1 wherein user responses are classified or scored using one or more XAI protocols in conjunction with one or more natural language processing (NLP) techniques.

13. The method of claim 1 wherein (i) one or more of the prompts or queries are aural prompts or queries, (ii) one or more of the user responses are oral responses, (iii) one or more of the prompts or queries are written prompts or queries, (iv) one or more of the user responses are written responses, (v) at least one user response is an essay written by the user in response to one of the prompts or queries, (vi) one or more of the prompts or queries are signed prompts or queries, or (vii) one or more of the user responses are signed responses.

14. The method of claim 1 further comprising, using one or more XAI protocols, automatically identifying one or more user responses that are consistent with one or more predetermined cheating patterns.

15. A programmed computerized machine comprising one or more electronic processors and one or more tangible computer-readable storage media operationally coupled to the one or more processors, the machine being structured and programmed to perform the method of claim 1.

16. An article comprising a tangible medium that is not a propagating signal encoding computer-readable instructions that, when applied to a computerized machine, program the computerized machine to perform the method of claim 1.

17. A method implemented using a programmed computerized machine, the method comprising:
(a) receiving, via a computer network, a local or remote user interface (UI), or an application program interface (API), or retrieving, from one or more local or remote digital storage media, one or more responses by a user to one or more corresponding prompts or queries pertaining to selected subject matter for assessing proficiency of the user in the selected subject matter; and
(b) using one or more XAI protocols, automatically identifying one or more user responses that are consistent with one or more predetermined cheating patterns.

18. The method of claim 17 wherein automatically identifying one or more user responses that are consistent with one or more predetermined cheating patterns includes directly comparing the user response to one or more known examples of cheating responses and detecting a match, overlap, or correlation between the user response and one of the known examples.

19. The method of claim 17 wherein automatically identifying one or more user responses that are consistent with one or more predetermined cheating patterns includes detecting inconsistency between a classification or score of the identified user response and classifications or scores of other, non-identified user responses.

20. The method of claim 17 wherein automatically identifying one or more user responses that are consistent with one or more predetermined cheating patterns includes detecting a typing rate for a written response, or a speaking rate for an oral response, for the identified response that is substantially faster than that of other, non-identified user responses.

21. The method of claim 17 wherein automatically identifying one or more user responses that are consistent with one or more predetermined cheating patterns includes recognizing patterns within the identified response indicative of a machine-generated response.

22. The method of claim 17 wherein automatically identifying one or more user responses that are consistent with one or more predetermined cheating patterns includes use of one or more NLP techniques in conjunction with one or more XAI protocols.

23. The method of claim 17 further comprising evaluating, using a human evaluator, the identified user responses, and only designating as cheating responses those identified user responses evaluated as such by the human evaluator.

24. The method of claim 17 wherein the selected subject matter is a specific written, spoken, or signed human language.

25. A programmed computerized machine comprising one or more electronic processors and one or more tangible computer-readable storage media operationally coupled to the one or more processors, the machine being structured and programmed to perform the method of claim 17.

26. An article comprising a tangible medium that is not a propagating signal encoding computer-readable instructions that, when applied to a computerized machine, program the computerized machine to perform the method of claim 17.
